(19) United States
(12) Patent Application Publication
(10) Pub. No.: US 2011/0036227 A1
(43) Pub. Date: Feb. 17, 2011

(54) MULTI SAW COMPOUND MITER JIG AND METHOD THEREFOR

(76) Inventors: William C. Stuart, Long Beach, CA (US); Vincent P. Zaldivar, Las Vegas, NV (US)

Correspondence Address: WEISS & MOY PC, 4204 NORTH BROWN AVENUE, SCOTTSDALE, AZ, 85251, US

(21) Appl. No.: 12/541,319

(22) Filed: Aug. 14, 2009

(51) Int. Cl. B27G 5/02

(52) U.S. Cl. 83/743; 83/581; 83/454

(57) ABSTRACT

A miter jig has a base member. A securing device is coupled to the base member to secure a workpiece to the base member. A saw blade guide is coupled to the base member. The saw blade guide is adjustable to hold different size saw devices. A position of the saw blade guide is adjustable to allow cuts of different angles and depths.

### BACKGROUND

Embodiments of this disclosure relate generally to a saw table, and more particularly, to a saw table which is designed to cut a workpiece at multiple angles to achieve a desired compound miter cut using an existing saw.

A miter joint is a joint made by cutting each of two parts to be joined. In general, each end may be formed at a 45° angle, to form a corner, usually a 90° angle when the two parts are joined together. A miter joint is often used in making picture frames and the like. Presently, in order to form accurate crosscuts and miters in a workpiece, a miter saw is generally required.

A miter saw may be a manual or motorized device. In a motorized miter saw, cuts are made by pulling a spinning circular saw blade down onto a workpiece in a short, controlled motion. The workpiece is typically held against a guide fence, which provides a precise cutting angle between the blade and the workpiece edge. In standard position, this angle is fixed at 90°.

A primary distinguishing feature of the miter saw is the miter index that allows the angle of the blade to be changed relative to the guide fence. While most miter saws enable precise one-degree incremental changes to the miter index, many also provide “stops” that allow the miter index to be quickly set to common angles (such as 15°, 30°, or 45°).

While many individuals may have an electric handsaw, a reciprocating saw, a manual hand saw or the like, most individuals do not have a miter saw. Forming a miter joint using an electric handsaw, a reciprocating saw, a manual hand saw is extremely difficult since there are no guides to form the precise cutting angle on the workpiece.

Therefore, it would be desirable to provide an apparatus and method that overcomes the above problems. The apparatus would allow one to cut a workpiece at multiple angles using an electric hand saw, a reciprocating saw, a manual hand saw, or the like.

### SUMMARY

A miter jig has a base member. A securing device is coupled to the base member to secure a workpiece to the base member. A saw blade guide is coupled to the base member. The saw blade guide is adjustable to hold different size saw devices. A position of the saw blade guide is adjustable to allow cuts of different angles and depths.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is an elevated perspective view of one embodiment of the miter jig of the present invention;

FIG. 2 is a side view of the miter jig of the present invention;

FIG. 3 is a front view of the miter jig of the present invention;

FIG. 4 is a top view of the miter jig of the present invention with the handsaw removed;

FIG. 5 is another elevated perspective view of the miter jig of the present invention with the handsaw removed and a portion of the saw blade guide 32 removed; and

FIG. 6 is a magnified view of the top surface of the miter jig of the present invention with the handsaw removed and a portion of the saw blade guide 32 removed.

### DETAILED DESCRIPTION

Generally described, the present invention relates to systems and methods for making accurate crosscuts and miters in a workpiece. In particular, the present invention allows a user to cut a workpiece at multiple angles to achieve a desired compound miter cut using an existing saw.

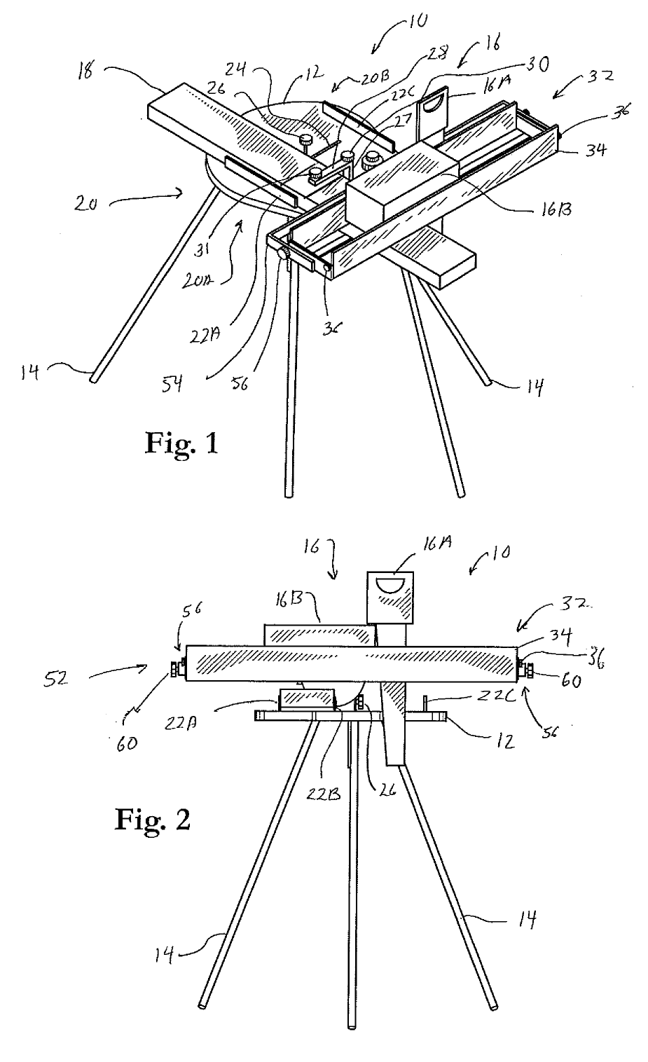

With reference now to FIG. 1, an elevated perspective view of a miter jig 10 of the present invention is shown. The miter jig 10 may have a base section 12. The base section 12 may be used to support the components of the miter jig 10 and is where a workpiece 18 is positioned when being cut. The base section 12 may be formed of an approximately level table top construction. The base section 12 may take on different shapes. In accordance with one embodiment, the base section 12 may be teardrop or oblong in shape.

A plurality of leg members 14 may be attached to the base section 12. The leg members 14 may be used to elevate the base section 12 above a surface. Elevating the base section 12, allows a saw 16 to more effectively cut the workpiece 18.

As shown in FIG. 2, if the saw 16 is a handsaw 16A, in order to more effectively cut a workpiece 18, full movement of the handsaw 16A is generally required. Elevating the base section 12 allows full motion of the handsaw 16A and further prevents the handsaw 16A or the blade of an electric saw 16B or reciprocating saw from contacting the surface on which the miter jig 10 may be placed. In accordance with the present embodiment, four leg members 14 are shown. However, the number of leg members 14 is not limited to the number shown.

The leg members 14 may be removably coupled to a bottom surface of the base section 12. This allows one to secure the miter jig 10 to an elevated surface such as a table top for use by clamping the base section 12 to the elevated surface. Removing the leg members 14 further allows for easier storage of the miter jig 10 when not in use. The leg members 14 may be removably coupled in a plurality of different manners. In accordance with one embodiment, each of the leg members 14 have a threaded end which mates with threaded openings formed on the bottom surface of the base section 12. The above is only given as one example and should not be seen as to limit the scope of the present invention.

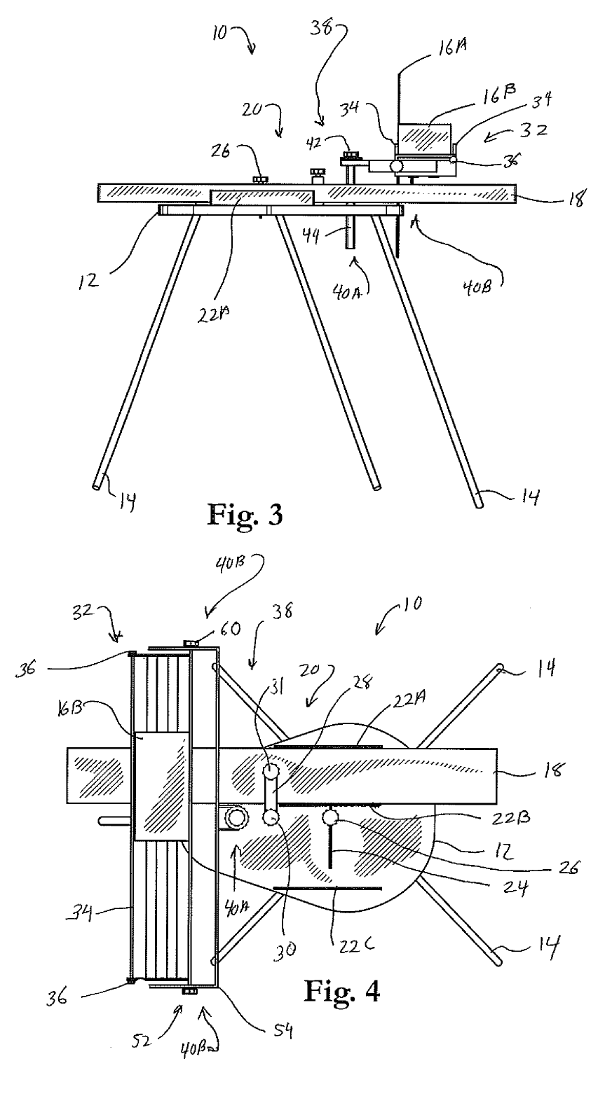

Referring to FIGS. 1-3, as may be seen, the leg members 14 may extend down and away from the base section 12. By angling the leg members 14 down and away from the base section 12, the leg members 14 provide more stability to the base station 12 and hence the miter jig 10.

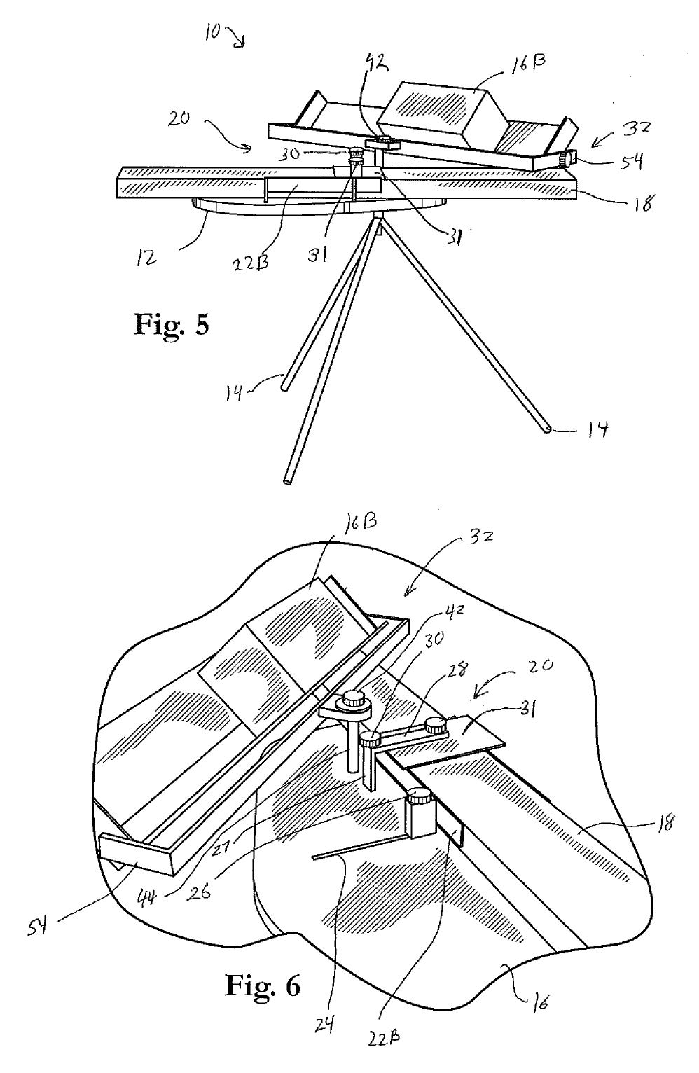

Referring now to FIGS. 4-6, the miter jig 10 may have a securing device 20. The securing device 20 may be attached to the top surface of the base section 12. The securing device 20 may be used to secure the workpiece 18 to the miter jig 10. The securing device 20 may be adjustable to accommodate different size workpieces 18.

In accordance with one embodiment, the securing device 20 may have a horizontal support 20A and a vertical support 20B. The horizontal support 20A may comprise a plurality of rails 22. A first rail 22A is coupled to a first side area on the top surface of the base section 12. The first rail 22A may extend upward from the top surface of the base section 12. The first rail 22A is of sufficient height to support the workpiece 18 and prevent the workpiece 18 from going over a top of the first rail 22A when the workpiece 18 is pushed against the first rail 22A.

A second rail 22B is movably coupled to the top surface of the base section 12. The second rail 22B may be moved to secure the workpiece 18 to prevent movement of the workpiece 18 along a horizontal plane. In accordance with one embodiment, a slot 24 is formed in the top surface of the base section 12. A locking device 26 is positioned in the slot 24. The locking device 26 is movably couple to the slot 24. The second rail 22B is coupled to the locking device 26 and thus movable along the top surface of the base section 12. Thus, the horizontal support 20A is adjustable to accommodate varying widths of different size workpieces 18. Once the second rail 22B is moved to push the workpiece 18 against the first rail 22A, the locking device 26 is secured in the slot 24 to lock the workpiece 18 between the first rail 22A and second rail 22B to prevent movement of the workpiece 18 along a horizontal plane. In accordance with one embodiment, the locking device 26 is a locking screw rotatable coupled to the slot 24. However, other devices may be used as the locking device 26 without departing from the spirit and scope of the present invention.

A third rail 22C may be coupled to a second side area on the top surface of the base section 12 opposite of the first rail 22A. The third rail 22C may extend upward from the top surface of the base section 12. The first rail 22C is of sufficient height to support the workpiece 18 and prevent the workpiece 18 from going over a top of the third rail 22C when the workpiece 18 is pushed against the third rail 22C. The third rail 22C will work in combination with the second rail 22B to secure and to lock the workpiece 18 between the second rail 22B and the third rail 22C to prevent movement of the workpiece 18 along a horizontal plane. In operation, the second rail 22B is moved to push the workpiece 18 against the third rail 22C, the locking device 26 is secured in the slot 24 to lock the workpiece 18 between the second rail 22B and the third rail 22C to prevent movement of the workpiece 18 along a horizontal plane. The first and third rails 22A and 22C respectively allow the miter jig 10 to adapt to left or right angled cuts.

In accordance with one embodiment, the vertical support 20B may have a support arm 27. The support arm 27 rotates on the base section 12. A horizontal arm member 28 extends from the support arm 27. The horizontal arm member 28 is pivoted over the workpiece 18. This is secured in place with a vertical support locking device 30. Another support arm 31 may extend down from the horizontal arm member 28. A rubber disc or other slip resistant material may be attached to a bottom surface of the support arm 31 and pivots to secure workpieces 18 of varying shapes and sizes. The vertical support locking device 30 may be adjustable to accommodate workpieces 18 of various heights. The vertical support locking device 30 may be a locking screw or the like. While the Figures only show one vertical support 20B, more than one vertical support device 20B may be used.

A saw blade guide 32 may be adjustably coupled to the base section 12. The saw blade guide 32 may be adjustable to accommodate different size saws 16 as well as adjustable to have the saw 16 form cuts of various angles and depths.

In accordance with one embodiment, the saw blade guide 32 may have a pair of support arms 34. The support arms 34 may be moveably coupled to each other so that the support arms 34 may be moved toward or away from each other according to the type of saw positioned in the saw blade guide 32 between the support arms 34. A locking device 36 may be used to secure the support arms 34 once the support arms 34 have been adjusted to accommodate the specific saw 16 being used.

The saw blade guide 32 may be coupled to adjustable axis support device 38. The adjustable axis support device 38 allows the saw blade guide 32 to move in a horizontal and vertical plane to allow the saw 16 to form cuts of various angles and depths. In accordance with one embodiment, the adjustable axis support device 38 may have a first miter axis 40A and a second miter axis 40B. The first miter axis 40A rotates on a vertical plane. With the rotation of this axis, the saw blade guide 32 rotates parallel to the ground. The second miter axis 40B rotates on a horizontal plane.

The first miter axis 40A may be a vertical rod member 44 which travels through the base section 12. To achieve a locked position, a first miter axis locking device 42 may be used. In accordance with one embodiment, the vertical rod member 44 is locked in position with a sleeve and locking screw that are secured to the base section 12. The rod member 44 may have multiple sides to prevent undesired rotation. A disc which have may serrations on its surface may be secured to the top of the rod member 44. This will meet another disc with serrations. Both are secured in place with a locking screw.

As stated above, the second miter axis 40B rotates on a horizontal plane and locked into position by a second miter axis locking device 52. In accordance with one embodiment, the second miter axis 40B comprises a “U” shaped bracket 54. The “U” shaped bracket 54 is rotatably coupled to the saw blade guide 32. The “U” shaped bracket 54 rotates on a horizontal plane. This is achieved with serrated discs 56 which are attached to each end of the “U” shaped bracket 54. Another serrated disc is attached to each end of the saw blade guide 32. After determining the angle desired, a locking screw 60 is tightened to secure the second miter axis 40B in position.

In order to achieve a cut at a desired position on the workpiece 18, there needs to be a mechanism to measure where the saw 16 is going to cut the workpiece 18. Thus a recessed ruler may be located on the base section 12. Since the user may not be able to see the cutting edge of the saw 16, a slide ruler may be used in conjunction with the recessed ruler. The slide ruler will travel through a vertical extension down from a horizontal member which is attached to the top disc of the first miter axis. One end of the slide ruler will extend towards the saw blade guide. The other end will have an extension down to the recessed ruler.

Referring now to FIGS. 1-6, in operation, a workpiece 18 of is placed on the base section 12 of the miter jig 10 between the two of the rails 22A-22C of the horizontal support 20A and secured in place by the locking device. Downward pressure is applied on the workpiece 18 using one or more vertical supports 20B.

The saw 16 is placed on the saw blade guide in the appropriate position. This is accomplished by adjusting the support arms 34 to the desired width and securing it in place by use of the locking device 36.

In order to obtaining a desired compound miter cut, the saw blade guide 32 is adjusted by rotating the first miter axis to the desired angle position. If a second angle is required, the first miter axis must be elevated to a higher position by maneuvering the first miter axis rod. Next, the second miter axis is placed in the desired position for cutting the second angle. The device 10 will now be ready to cut the board and achieve the desired compound miter cut.

If a mechanism to measure where the saw 16 is going to cut the workpiece 18 is available, the slide ruler is extended and contact is made with the saw blade. The vertical extension at the end of the slide ruler will indicate on the recessed ruler the distance from the cut to be made and the visual distance the workpiece 18 is from the saw blade.

While embodiments of the disclosure have been described in terms of various specific embodiments, those skilled in the art will recognize that the embodiments of the disclosure can be practiced with modifications within the spirit and scope of the claims.

What is claimed is:

1. A miter jig comprising:
a base member;
a securing device coupled to the base member to secure a workpiece to the base member; and
a saw blade guide coupled to the base member, wherein the saw blade guide is adjustable to hold different size saw devices, a position of the saw blade guide being adjustable to allow cuts of different angles and depths.

2. A miter jig in accordance with claim 1 further comprising a plurality of leg members attached to a bottom surface of the base member.

3. A miter jig in accordance with claim 1 further comprising a plurality of leg members removably coupled to a bottom surface of the base member.

4. A miter jig in accordance with claim 1 wherein the securing device comprises:
a horizontal support to prevent the workpiece from moving in an approximately horizontal direction on the base member; and
a vertical support to prevent the workpiece from moving in an approximately vertical direction on the base member.

5. A miter jig in accordance with claim 4 wherein the horizontal support comprises:
a first rail coupled to a first side area on a top surface of the base section; and
a second rail movably coupled to the top surface of the base section, wherein the workpiece is secured between the first rail and the second rail.

6. A miter jig in accordance with claim 5 wherein the horizontal support further comprises:
a slot formed in the top surface of the base section;
a horizontal support locking device positioned in and movably couple to the slot, wherein the second rail is coupled to the locking device.

7. A miter jig in accordance with claim 5 wherein the horizontal support further comprises a third rail coupled to a second side area on the top surface of the base section opposite of the first rail, wherein the workpiece is secured between the third rail and the second rail.

8. A miter jig in accordance with claim 4 wherein the vertical support comprises:
a support arm coupled to the base section;
a horizontal arm member extending from the support arm; and
a vertical support locking device.

9. A miter jig in accordance with claim 8 wherein the vertical support further comprises:
a second support arm extending down from the horizontal arm member; and
skid resistant material attached to the second support arm.

10. A miter jig in accordance with claim 1 wherein the saw blade guide comprises a plurality of support arms moveably coupled together to allow the plurality of support arms to adjust and hold a saw positioned between the support arms.

11. A miter jig in accordance with claim 10 wherein the saw blade guide further comprises a saw blade guide locking device to secure the plurality of support arms together.

12. A miter jig in accordance with claim 1 further comprising an adjustable axis support device coupled to the saw blade guide to allow the saw blade guide to move in a horizontal and vertical plane.

13. A miter jig in accordance with claim 12 wherein the adjustable axis support device comprises:
a first miter axis coupled to the saw blade guide to allow the saw blade guide to rotate on a vertical plane; and
a second miter axis coupled to the saw blade guide to allow the saw blade guide to rotate on a horizontal plane.

14. A miter jig in accordance with claim 12 wherein the first miter axis comprises:
a vertical rod member which travels through the base section; and
a first miter axis locking device coupled to the vertical rod member.

15. A miter jig in accordance with claim 12 wherein the second miter axis comprises:
a “U” shaped bracket rotatably coupled to the saw blade guide; and
a “U” shaped bracket locking device coupled to the “U” shaped bracket.

16. A miter jig comprising:
a base member;
a securing device coupled to the base member to secure a workpiece to the base member, wherein the securing device comprises:
a horizontal support to prevent the workpiece from moving in an approximately horizontal direction on the base member; and
a vertical support to prevent the workpiece from moving in an approximately vertical direction on the base member;
a saw blade guide coupled to the base member, wherein the saw blade guide is adjustable to hold different size saw devices, a position of the saw blade guide being adjustable to allow cuts of different angles and depths; and
an adjustable axis support device coupled to the saw blade guide to allow the saw blade guide to move in a horizontal and vertical plane, wherein the adjustable axis support device comprises:
a first miter axis coupled to the saw blade guide to allow the saw blade guide to rotate on a vertical plane; and
a second miter axis coupled to the saw blade guide to allow the saw blade guide to rotate on a horizontal plane.

17. A miter jig in accordance with claim 16 wherein the horizontal support comprises:
a first rail coupled to a first side area on a top surface of the base section;
a second rail movably coupled to the top surface of the base section, wherein the workpiece is secured between the first rail and the second rail;
a slot formed in the top surface of the base section;
a horizontal support locking device positioned in and movably couple to the slot, wherein the second rail is coupled to the locking device.

18. A miter jig in accordance with claim 16 wherein the vertical support comprises:
a support arm coupled to the base section;
a horizontal arm member extending from the support arm; and
a vertical support locking device.

19. A miter jig in accordance with claim 16 wherein the saw blade guide comprises:
a plurality of support arms moveably coupled together to allow the plurality of support arms to adjust and hold a saw positioned between the support arms; and
a saw blade guide locking device to secure the plurality of support arms together.

20. A miter jig comprising:
a base member;
a securing device coupled to the base member to secure a workpiece to the base member, wherein the securing device comprises:
a horizontal support to prevent the workpiece from moving in an approximately horizontal direction on the base member, wherein the horizontal support comprises:
a first rail coupled to a first side area on a top surface of the base section;
a second rail movably coupled to the top surface of the base section, wherein the workpiece is secured between the first rail and the second rail;
a slot formed in the top surface of the base section;
a horizontal support locking device positioned in and movably couple to the slot, wherein the second rail is coupled to the locking device; and
a vertical support to prevent the workpiece from moving in an approximately vertical direction on the base member, wherein the vertical support comprises:
a support arm coupled to the base section;
a horizontal arm member extending from the support arm; and
a vertical support locking device;
a saw blade guide coupled to the base member, wherein the saw blade guide is adjustable to hold different size saw devices, a position of the saw blade guide being adjustable to allow cuts of different angles and depths, wherein the saw blade guide comprises:
a plurality of support arms moveably coupled together to allow the plurality of support arms to adjust and hold a saw positioned between the support arms; and
a saw blade guide locking device to secure the plurality of support arms together; and
an adjustable axis support device coupled to the saw blade guide to allow the saw blade guide to move in a horizontal and vertical plane, wherein the adjustable axis support device comprises:
a first miter axis coupled to the saw blade guide to allow the saw blade guide to rotate on a vertical plane; and
a second miter axis coupled to the saw blade guide to allow the saw blade guide to rotate on a horizontal plane.
